(19) United States
(12) Patent Application Publication
(10) Pub. No.: US 2024/0051645 A1
(43) Pub. Date: Feb. 15, 2024

(54) UNDERWATER ROBOT FOR REMOVING MARINE BIOFOULING FROM HULLS OF FLOATING UNITS, WITH SYSTEM FOR CONTAINING AND CAPTURING WASTE

(71) Applicants: PETRÓLEO BRASILEIRO S.A. – PETROBRAS, Rio de Janeiro (BR); SERVIÇO NACIONAL DE APRENDIZAGEM INDUSTRIAL - DEPARTAMENTO REGIONAL DA BAHIA-SENAI/DR/BA, Salvador (BR)

(72) Inventors: Marcelo Luiz LIGEIRO BARBOSA, Rio de Janeiro (BR); Edisiene DE SOUZA CORREIA, Salvador (BR); Lucas SARMENTO NEVES DA ROCHA, Salvador (BR); Edna DOS SANTOS ALMEIDA, Salvador (BR); Mateus DOS SANTOS DE MENESES, Salvador (BR); Carlos Eduardo DA SILVA JORGE, Salvador (BR); Frederico GARCIA DE OLIVEIRA, Salvador (BR); Luis Carlos MORENO LEDEZMA, Salvador (BR); Alexandro QUIRINO DA SILVA, Salvador (BR); Joaquim RANYERE SANTANA DE OLIVEIRA, Salvador (BR); Valter ESTEVÃO BEAL, Salvador (BR); Saulo QUEIROZ FIGLIUOLO, Salvador (BR); Danilo MARQUES FERREIRA, Salvador (BR); Gustavo DOS SANTOS CUNHA, Salvador (BR); Érika DURÃO VIEIRA, Salvador (BR)

(21) Appl. No.: 18/260,014

(22) PCT Filed: Dec. 20, 2021
(86) PCT No.: PCT/BR2021/050569

§ 371 Date: Jun. 29, 2023

(30) Foreign Application Priority Data
Dec. 30, 2020 (BR) 10 2020 027018 4
Dec. 3, 2021 (BR) 10 2021 024485 2

(51) Int. Cl. B63B 59/08; B63G 8/00; B63G 8/39; B63G 8/38; B63G 8/14; B62D 55/265; B63G 8/08

(52) U.S. Cl. CPC B63B 59/08; B63G 8/001; B63G 8/39; B63G 8/38; B63G 8/14; B62D 55/265; B63G 8/08; B63G 2008/005

(57) ABSTRACT

The present invention relates to a remotely operated underwater robot device for removing marine biofouling, mainly aimed at organisms such as sun coral, settled on hulls of floating units for transporting oil and derivatives thereof, or on exploration and production platforms. The system comprises a remotely operated robot that removes the marine biofouling from said hulls, without damaging the hull, containing and capturing the waste. It is an intelligent device that is capable of operating in two modes: as an ROV to allow it to travel through the water, and as a crawler to perform the actual functions of removing the macrofouling containing sun coral and the functions resulting therefrom. It has non-georeferenced reference systems using acoustic elements to facilitate location by the operator. It uses computer vision to enter the parking areas without human assistance. It contains thrusters for controlling aquatic movements and self-levelling systems with control of the centre-of-buoyancy dynamics, and has wheels for movement, which can be electromagnets or a set of wheels that works in conjunction with a magnetic fastening system, both with variation in the coupling force. It has either a system for removing, containing, capturing and crushing the biofouling or a removal system using cavitation and mechanical impact that can have an approximate height of 30 centimetres, normally applied to sun coral.

### FIELD OF THE INVENTION

The present invention is related to the removal of bio-scales in the hulls of marine vessels that carry out offshore operations and transport of crude and derivatives. More particularly, the present invention is related to a teleoperated underwater robot that contains a built-in residue containment and capture system to act on bio-scales, normally containing invasive species from other oceans, such as Sun Coral.

The present invention proposes in its broadest form a marine bio-scaling removal system predominantly composed of calcareous organisms with a rigid skeleton such as stony or scleractinous corals, with the possibility of the presence of fibrous organisms, up to 30 centimeters thick, here designated macro-scaling, and sending the bio-residue generated after removal to a remote modular unit for treatment of the generated effluent.

### DESCRIPTION OF THE STATE OF THE ART

Marine bio-scaling occurs on FPSO hulls, semi-submersible platforms, support/service vessels and similar ship hulls, and may be up to 30 centimeters thick. This thick layer increases resistance to slipping in water and, consequently, fuel consumption, as well as causing corrosion on the surface, in addition to increasing the weight of the vessel.

Due to the development of bio-scaling on vessels, platforms and floating structures in general, these bulkheads are one of the main vectors of dispersion and introduction of exotic species in the marine environment. The aim is to contain and control the population of these proliferative species due to the potential impacts on native species, which may reduce or affect the biodiversity of the Brazilian coast.

One of the main invaders of Brazilian biodiversity is Sun Coral, from the Pacific Ocean, known since the 80s, for having invaded the rocky shores of the coast. Some studies have proven that sun coral is an efficient invader, with rapid growth. The sun coral modifies the invaded environment, creating a favorable environment for its permanence, and, for that, it produces harmful chemical substances, which excludes some actors of the native fauna and flora. The sun coral was also observed killing native coral species, some even endemic to Brazil, competing with species of economic value, such as the mussel, affecting primary and coastal productivity (fisheries and sea resources), thus harming a source of food.

National laws require the identification, monitoring and elimination of non-native organisms that have settled in natural areas of biological importance. The aim is to eliminate these proliferative species due to the impacts on native species, which may reduce or affect the biodiversity of the Brazilian coast. This motivation created the need of designing a robot that promotes the removal and collection of vectors that use the hull of vessels to spread around the world, compromising in this case the marine habitat of the country.

The scales interfere negatively because they bring an additional load to a design that, possibly, did not take into account such excess weight, bringing structural and/or stability problems (buoyancy).

Scaled ships suffer from increased drag (greater friction with water), and have their displacement speed reduced, increasing fuel consumption.

The hulls range from flat geometries with large radius of curvature to more complex geometries with niche areas, such as riser counters, hull protection structures, structural reinforcements, areas of difficult access, etc.

Commonly, the removal of bio-scaling both on the hull and in difficult places is performed by divers equipped with appropriate tools, and the removed material may not be completely withdrawn, but rather left in the environment. The operation presents risks for the operator due to the large extension and irregularities of the surface, as well as for the environment, since invasive species and fragments of surface paint containing heavy metals or other harmful substances spread in the environment, disrupting the balance of that subsystem.

The development of technologies that do not require human diving is essential to provide safer operations. In this context, the design of a robotic system for the removal of bio-scaling presents itself as an excellent alternative for reducing costs and human exposure to this type of operation. Likewise, it is important that the system is coupled to an effluent treatment module containing bio-scaling, which guarantees the proper disposal of solid residues generated and return of liquid effluent to the sea (free of living organisms), preventing the proliferation of exotic species. With the development of technologies, it is currently possible to replace human labor in this activity, thus providing a more efficient and safer operation.

Current systems that could meet this task were found in documents U.S. Pat. No. 7,905,192B1, WO2019028562A1, JP2008018745A, WO2018096214A1, GB2528871A and US20140230711, but have a number of limitations for the technical problem presented here, so that simple adaptations of the solutions disclosed in these documents would not be adequate for the removal of macro-scales, here called scales of up to 30 centimeters, but for the removal of thinner bio-scaling, predominantly formed by algae, mussels and barnacles, here designated micro-scale.

The system claimed in document U.S. Pat. No. 7,905,192B1 comprises an integrated cleaning and treatment system comprising a vehicle consisting of a compartment provided with brushes for removing bio-scaling and a compartment for separating solids from bio-scaling, and these solids are pumped to a station for treatment by means of a flexible hose. This vehicle needs to be driven by an operator, the mechanical strength of the brush bristles is considered low due to its slenderness index, which limits the removal in the body of calcium carbonate, in particular, sun coral; adding to this factor, there is the capture that is connected to a pump without the intermediary of a crusher, which causes a low flow of solid/liquid or a total obstruction of the system.

Document WO2019028562A1 discloses a self-propelled machine guided by an operator for removing bio-scaling that is connected to a treatment unit, although this unit is not included in the invention.

Document JP2008018745A refers to an underwater cleaning robot to remove organisms such as blue mussels and red barnacles growing on a submerged surface. The locomotion system of said robot is carried out by thrusters and guide wheels. The forces generated by the thrusters are used to press the robot against the surface to be cleaned, generating a fluid dynamic disturbance, which is a major inconvenience, as it generates vibrations in the water causing some coral species to potentially release their planulae into the environment. This underwater cleaning robot includes a scraping device that scrapes off the living organism that has settled on the surface of the wall. The underwater cleaning robot sucks up the organisms scraped by the scraping device. A crushing device crushes the organisms that are sucked through a suction port in a storage unit.

The crushing device described in this document JP2008018745 is configured by a rotating crushing drum positioned in an earlier stage and a rotating shearing drum positioned in a subsequent stage of the rotating crushing drum. The disclosed crushing system has a design that is not suitable for crushing macro-scales, such as sun coral, as the sectioned material is not reduced in size before being sent to the rollers, which could cause clogging. There is a grip limitation by the rollers of larger particles, which is a characteristic of macro-scales, in particular, of coral colonies whose structural strength is greater than that of adhesion to the hull, increasing the possibility of detaching entire colonies during removal. Adding to this, there is the fact that the solid particles have heterogeneous characteristics, containing algae, fibrous and carbonaceous elements, favoring the obstruction of the passage destined for the passage of water, causing the obstruction of the system. In the proposed system, object of the present invention, this phenomenon does not happen due to the fact that the reduction of macro-scaling particles size happens in a staggered way or simultaneously by means of shearing devices besides the existence of devices that avoid the obstruction of the removal, capture and crushing system as can be seen in the detailed description below.

In a flow of a two-phase system, the solid particles have their residence time longer than the liquid phase when they pass through the rollers during crushing. In this way, the fluid flow rate is reduced due to the generated obstruction, compromising the capture efficiency, which is enhanced when there are rollers in series. In addition, when the fragments do not reach the desired sizes, they are recirculated through the crushers again, increasing head loss and reducing the overall efficiency of the system.

Document WO2018096214A1 discloses an ROV device for maintenance of underwater marine vessels that is capable of traveling over a ferrous surface. The ROV device has a continuous track that grips the ferrous surface with electromagnets, while the apparatus performs maintenance tasks on the vessel hull. The ROV can be used for selecting subsea tasks for marine vessels, such as cleaning or inspecting ship hulls. The ROV can carry various devices for various purposes, such as cameras, suction ports, brushes, lights, UV lights, sonars or devices for underwater analysis or surveillance. The ROV may comprise an umbilical cord connected to the host, for example on the ship deck which carries information or consumables such as electrical power between the ROV and the host. The umbilical cord can deliver debris or scales detached from the hull or helix to the host for further residue management. Debris can be filtered and collected, thus allowing the use in ports or locations with environmental limits. In this invention, dimensions and versatility are not observed for the device to be able to perform tasks to eliminate Sun Coral, it was even developed to have a rotating arm, with the objective of cleaning low-thickness scales, the micro-scales, and therefore, it also does not have a crushing system according to the invention proposed herein. The differential of this device lies in the existence of a coupling system through a suction module that allows rotation on its own shaft, giving greater flexibility in the mobility of the robotic platform. Even if this device were applied to remove marine bio-scaling, it would not be suitable for macro-scaling removal, nor would it efficiently contain and capture the material, as is the purpose of the present invention.

Document GB2528871A discloses a remotely operated vehicle (ROV) for cleaning and/or inspection of hulls, comprising an on-board hydraulic power unit (HPU), electrically driven. It comprises one or more tracks for providing grip and traction on a hull, the track comprising a plurality of magnetic elements. The vehicle is controlled by an on-board PLC (programmable logic controller), using on-board sensors and operator inputs, with data communication to the surface control console via an optical Ethernet connection. The ROV may comprise modular cleaning elements, with different modules allowing the surface cleaning to be done by various processes including, but not limited to, brushes with rotational shaft normal to the surface, brushes with rotational shaft parallel to the surface, or water jet. The ROV can withdraw the bio-scaling and cleanup debris and return the same to the surface via an umbilical, or store the same on-board. The ROV may comprise thrusters and ballast adjustment that allow it to swim through the water, allowing it to maneuver through the water to a ferritic surface and attach. The ROV may comprise one or more cameras to transmit live video to a surface control console. In spite of all these elements, this vehicle does not serve to the removal of scales of up to 30 centimeters, the macro-scales, and also does not have a crushing device, only bringing brushes of the Rilsan type.

Document WO2018061122A1 discloses a simple surface or wall moving robot device and a surface or wall moving method, which can use an attractive magnetic force efficiently, providing stable movement on a ferritic metal surface or wall. The robot comprises a rotating brush for cleaning the surface as it travels across the same. The document, in addition to not disclosing a device for crushing scaling organisms according to the invention, does not clearly disclose how the vehicle is operated.

Document US20140230711A1 discloses a robot device focused on solutions for a certain attractive force pulling the same towards the structure, mainly vertical. Such a force can be exerted by an electromagnet or a permanent magnet, causing a tool bearing or a movable chassis of the device to grip a ferrous surface, being maneuvered over the surface of a ship hull. The alleged differential for this device is the magnetic attachment system that uses a permanent magnet system, these are allocated inside the wheels, or electromagnets, varying only the distance between the magnet and the surface. It further discloses a series of embodiments containing tools for cleaning surfaces, including by jet, but none of them discloses a device for crushing scaling organisms according to the invention.

Regarding the bio-scaling removal system, documents WO2018096214A1, GB2528871A, WO2018061122A1 and US20140230711A1 present solutions already known from the state of the art such as brushes, rollers or blasting. These removal systems are sized to remove scales with a maximum thickness of 1 cm. Therefore, they are not suitable for removing rigid macro-scales that may contain calcareous and fibrous organic material with thicknesses of up to 30 centimeters. Another relevant factor is that, as noted, no document has an efficient system of containment and capture of bio-scaling for subsequent treatment, thus potentiating that unwanted (exotic) species release planulae during the removal activity, not being relevant when compared to systems of removal, capture and crushing of the present invention.

With the development of technologies as shown, it is currently possible to replace human labor in loco in this activity, thus providing a more efficient and safer operation.

The invention can be fully applied to meet environmental restrictions which involve the removal of marine bio-scaling containing sun coral from the hulls of floating units (FPSO, SS, NS and service/support vessels and similar hulls).

In order to solve the related problems, the present invention was developed to meet not only the environmental requirements related to bio-scaling, mainly referring to macro-scales containing Sun Coral, but it was also developed with a focus on increasing productivity through a more efficient and faster removal than presented in the state of the art; and with an economic focus, since the faster the removal, the sooner a unit (FPSO, SS, etc.) is released for its core activity, avoiding production losses due to downtime waiting for the removal of marine bio-scaling from the hull.

### SUMMARY OF THE INVENTION

The proposed invention is an intelligent equipment capable of acting in two modes: ROV, to allow it to navigate in the water, and Crawler to carry out the proper functions and consequent removal of macro-scale containing sun coral.

In order to remove, capture and transport bio-scaling, the underwater operating robot invention was divided into subsystems, as shown in FIG. 1. This division is intended to facilitate and map the possible components and systems of the robot, decomposing the complexity of the final solution into smaller parts.

The invention was conceived containing a robotic unit that adheres to ferromagnetic hulls, by electromagnets, alternatively electromagnets together with permanent magnets, following the path, an internal module being inserted containing a unit for removal, crushing and accommodation of residues, which sends the removed material to a modular system for effluent treatment (MSET), described in another application for invention titled Modular System for Treatment of Effluents from the Cleaning of Floating Unit Hulls.

The teleoperated robotic system eliminates the need for human diving at any steps of the processes of removal, containment and capture of marine bio-scaling removed from the hull.

The present invention foresees the need for an operator to position the front region of the robot, in charge of the removal, close to the macro-scaling. The teleoperated robot, object of the present invention, is capable of removing, capturing and crushing bio-scaling, containing sun coral and a dense number of marine organisms that have a calcareous skeleton, such as corals, referred to here as macro-scaling.

### DESCRIPTION OF DRAWINGS

In the drawings, there are:

FIG. 1 shows a diagram of the subsystems of the robot.

FIG. 2 shows a schematic of the robot in modules.

FIG. 3 illustrates the teleoperated underwater robot of the embodiment 1 showing the body with its external protective fairing.

FIG. 4 shows the ability of the robot of the embodiment 1 to adapt to different curvatures due to the division into independent modules. The robot in this state is shown without the protective fairing.

FIG. 5 shows the detailed division of the robot of the embodiment 1 into 3 separate modules: front, central and rear part.

FIG. 6 shows the top view of the robot of the embodiment 1.

FIG. 7 shows a top view of the robot of the embodiment 1 with its main components.

FIG. 8 shows the rear view of the robot of the embodiment 1 detailing the components allocated in the rear module.

FIG. 9 shows a side view of the robot of the embodiment 1 and with details of externally visible components.

FIG. 10 shows a front view of the robot of the embodiment 1 with the main sensors arranged in this module.

FIG. 11 shows an isometric view of the robot of the embodiment 1 containing all the sensors installed therein.

FIG. 12 illustrates the 360° field of view of the front part, rear and sides of the robot of the embodiment 1.

FIG. 13 illustrates changing the center of buoyancy of the robot of the embodiment 1 to facilitate the maneuverability thereof.

FIG. 14 illustrates internal details of the removal, containment, capture and crushing system of the robot of the embodiment 1.

FIG. 15 shows a view containing the filled parts of the removal system of the robot of the embodiment 1.

FIG. 16 illustrates details of the blades of the removal, containment and capture system of the robot of the embodiment 1.

FIG. 17 shows details of the self-cleaning system of the removal, containment and capture system of the robot of the embodiment 1.

FIG. 18 shows a view of the crushing system of the robot of the embodiment 1.

FIG. 19 shows the pump suction pipes of the crushing system of the robot of the embodiment 1.

FIG. 20 illustrates the inside of the roller shaft and filter of the crushing system of the robot of the embodiment 1.

FIG. 21 illustrates the component of the wheel system and its motors of the embodiment 2.

FIG. 22 illustrates an isometric view of the assembly responsible for attachment to the metal surface of the embodiment 2.

FIG. 23 illustrates a side view showing the two degrees of freedom that allow the adaptability of the attachment system on the metal surface.

FIG. 24 shows a bottom view of the robot of the embodiment 2, highlighting the drive system consisting of the set of four wheels and respective motors and the positioning of the attachment systems.

FIG. 25 illustrates the proper positioning for the attachment system and the sets of wheels in the front and rear modules of embodiment 2.

FIG. 26 illustrates the robot of the embodiment 2, highlighting the part of the front module containing the passive containment mechanism, the canvases and the curtain.

FIG. 27 illustrates in detail how the curtain segment is composed and its preferred construction shape.

FIG. 28 shows the expected behavior of the curtain segments when encountering a solid scale material.

FIG. 29 illustrates the cavitation removal system consisting of the set of cavitation lances.

FIG. 30 illustrates the discs of the mechanical impact removal system.

FIG. 31 shows the structure and components of the mechanical impact removal system.

FIG. 32 shows the three-bar mechanism and its parts that serve to promote the relative movement between the modules.

FIG. 33 shows the installation of the three-bar mechanism in which the hydraulic cylinders are located in the central module, making it possible to act on the other modules.

FIG. 34 shows the robot of the embodiment 2 with the outer fairing.

### DESCRIPTION OF THE INVENTION

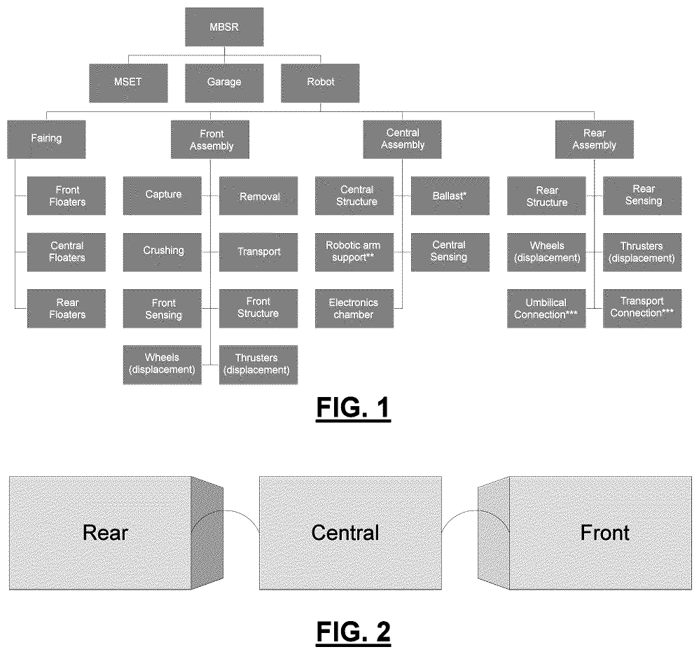

The underwater robot project for Marine Bio-scaling Removal (MBSR) was designed to be divided into 3 independent conceptual parts. The first part consists of the concept of invention presented herein, represented by the detailing of the two preferred embodiments of the underwater robot that will perform the task of removing bio-scales in the field. The second part consists of the use of a support vessel that will contain not only the Robot Garage, but an integrated control and operation system for the Robot and MSET, as well as a launch system at sea, which are described in the document BR 10 2020 026998-4. And the third part consists of the Modular System for Effluent Treatment (MSET), which processes all the residues generated during the removal operation by the Robot described in 10 BR 2020 027017-6. FIG. 1 illustrates the project where the present invention is inserted, in which the part comprised by the inventive concept of the Bio-scaling Removal Robot basically consists of subsystems inserted within modules, namely: the front, central and rear assemblies or modules. The connections between the modules are through a point that contains non-rigid mechanical attachments and through another point containing a damping system consisting of active cylinders.

The underwater operating robot has the ability to operate in flat areas and large radii, comprising concepts suited to the challenges and particularities of the environment in which it must operate, such as: non-uniform surfaces (unevenness, large radii); forces from the environment where it must operate (waves, sea currents); avoidance of bio-scaling after removal; need of moving around in an underwater environment; locomotion when adhered to the hull of FPSO, SS, NS type vessels and vessels (RSV, PSV, AHTS, PLSV, SDSV and similar hulls), Typical hull (FPSO, UMS and NS), and Semi-submersible hull (SS). The division of the robot into modules, as shown generically in FIG. 2, is convenient because it enables its adaptation to surfaces of concave and convex radii and, consequently, ensures that its entire structure is in contact with the surface.

The robot is deployed in the water from a launch system built for such an operation. After releasing the robot, the operator will operate it in ROV form, where the operator will control the same via a specialized control for moving ROVs, in which the software will transform the commands made by the operator into information for the thrusters placed on the robot. Thrusters are typically marine helices driven by hydraulic or electric motors mounted on an underwater robot as a propelling device. This gives the robot movement and maneuverability against the resistance of the fluid in which it is submerged.

Internally, the robot has a self-leveling and self-attitude system, with which the robot will automatically adapt to stresses from the environment. In ROV mode, the robot will have a non-georeferential localization system (location coordinates in a given reference system to be established in each mission), which, based on the fusion of data from these sensors, the system gives the operator the location of the robot in relation to the support vessel. The altitude and attitude of the robot are data that the sensors provide; in this case, the altitude is given as a function of the sea floor and the attitude in relation to the main shafts of the robot. The USBL system is based on the transmission and reception of an acoustic signal transmitted and received by a transducer containing multi-elements installed on the bottom of the vessels, that is, it compares the phase at the arrival of the pulse, also called ping, among these multi-elements to determine the angle and distance between the transponder and the transducer.

When the robotic platform is close to the metal surface, the robot must translate and rotate until it is parallel to the surface to which it will couple. To carry out this operation, the robot will be able to change its buoyancy center by means of a dynamic buoyancy system (37), as shown in FIG. 13. This system consists of air reservoirs (7) that can be filled with air from the auxiliary system of the support boat, see FIG. 7. As the air fills these reservoirs, the displaced volume coming from the reservoir to be filled will cause a change in the dynamics of the robot when it is submerged, thus allowing greater control of the system. Just as changing the buoyancy center of the robot can be one way, the other option is to change the power of each Thruster individually, forcing the robot to stay in the required position, both solutions can be achieved by the robot. Another solution that the system contemplates is the use of mobile weights, called ballast. These mobile weights use the same mechanism shown in FIG. 13; however, instead of changing the center of buoyancy, the center of mass is displaced, so the rotation of the body would occur due to the variation of this center of mass.

The components of the subsystems of each module are shown in FIG. 1. The central module houses wheels, coupled or not to a track, an electromagnetic attachment system, which may include a permanent magnet, a power plant, a support for a robotic arm, and may also comprise sensors. The rear module houses the wheels, coupled or not to a track, an electromagnetic attachment system, which may include a permanent magnet, thrusters, sensors and umbilical connection. The front module houses the bio-scaling removal, capture, crushing and transport system, as well as wheels, coupled or not to a track, an electromagnetic attachment system, which may include permanent magnets, thrusters and sensors.

Because the robot is divided into modules, the modules have mechanical attachments (16) at one point and active cylinders (17) at another point to dampen the relative movement between the modules and help the robot conform to surfaces with large radii, whether convex or concave. This occurs because, when the robot will attach itself to the surface, not necessarily all the modules will be in contact with the metallic hull; therefore, it is necessary that there are actuators that conform the body so that the modules and electromagnets come into contact with the surface. When in ROV mode, the active cylinders will provide greater stability between modules, inhibiting relative movement between them and thus enabling greater robot stability. The robot chassis is made in a modular way and hollowed out so that stresses from the environment are minimized.

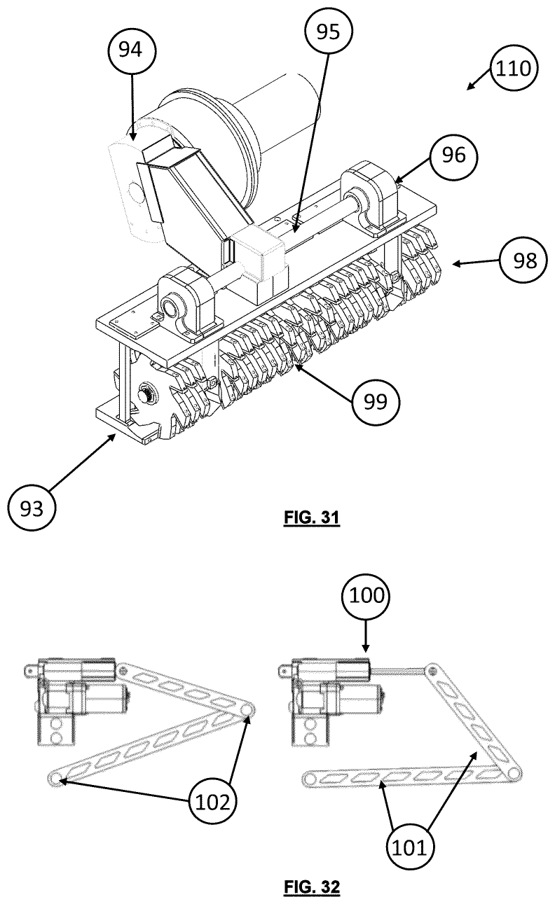

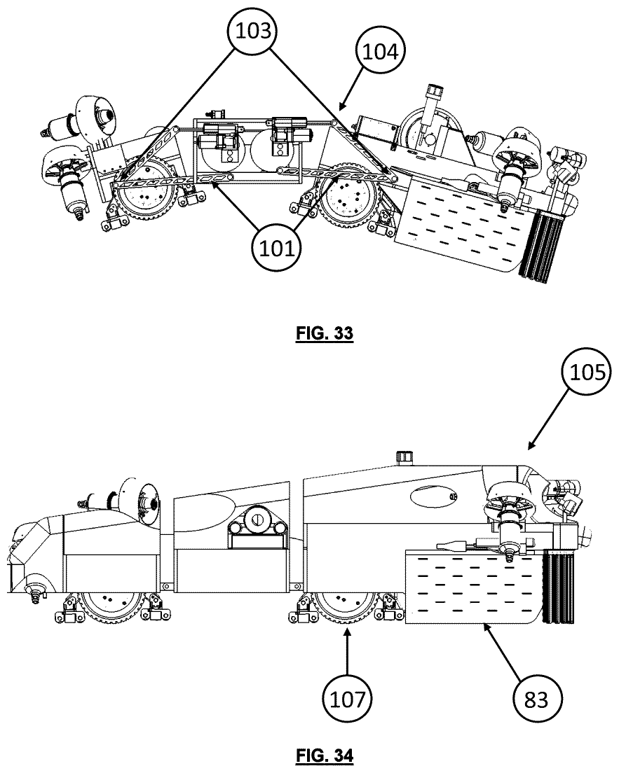

In another alternative configuration, the modules are connected by a three-bar mechanism (104), driven by a linear actuator (100). This mechanism provides the robot with greater flexibility, thus ensuring its adaptation to large radii, as well as overcoming obstacles, as seen in FIG. 32 and FIG. 33. To overcome an obstacle ahead, the operator activates the front linear actuators (100), causing the vertical movement of the front module of the robot (105) moving against the surface of the hull. When the robot is in ROV mode, all linear actuators are activated in predetermined positions, thus ensuring the rigidity of the system, preventing the modules from having degrees of freedom between them.

The mechanism (104) consists of two metal links of different sizes (101), with ball joints (102) at their ends, in addition to the hydraulic cylinder. When this is actuated, it allows the system to move, thus transferring the connection between the two metallic links. This connection, in turn, is interconnected with the structure (103) of the robot, in order to provide the robot with adaptability and the ability to overcome obstacles.

The removal and capture system may comprise mechanisms sized for underwater environments to remove bio-scales arranged in the hulls of floating units. These mechanisms can perform different methods of removal, such as cavitation, impact and vibration. The methods can be used simultaneously or in steps, depending only on the conditions of the surface to be cleaned and the characteristics of the environment.

The removal and capture system may comprise: a set of mechanisms for the bidirectional application of shear forces from the use of the rotational action of the crushing system itself or by means of an exclusive device for generating said principle. In addition to having a cavitation blasting system using a set of lances distributed along the entire length of the capture opening of the robot, guaranteeing, in any case, the total containment of the particles removed from the use of a suction force coming from the central part of the robot, together with the containment system.

The capture subsystem may comprise mobile or attached elements in order to inhibit the dispersion of oocytes and organic particles to the seabed shortly after the cleaning operation. These components can act passively, acting only by stresses from the environment or from the robot itself, or actively, being operated from actuators based on the need for the operation.

The crushing system may comprise one or more comminution devices operating sequentially or simultaneously in which the removed particles are broken down until they reach a certain granularity and size. The system can consist of elements that crush and remove bio-scaling simultaneously without the need for multiple steps, reducing operating time and manufacturing complexity.

### DETAILED DESCRIPTION OF THE INVENTION

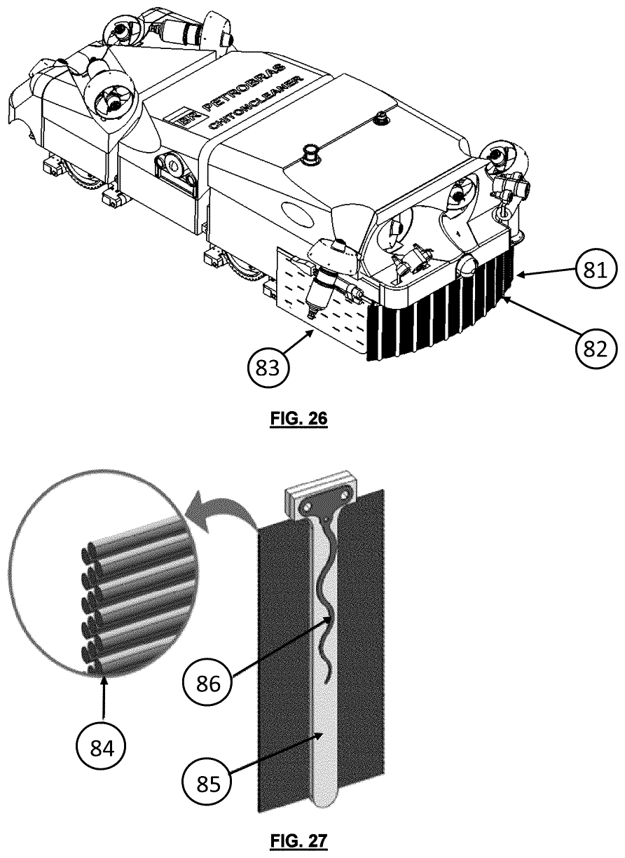

The present invention will be described in more detail from the description presented through embodiment 1 (FIG. 3) and embodiment 2 (FIG. 26), with reference to the attached figures which, in a schematic and non-limiting way of the inventive scope, represent examples of embodiment thereof.

### Embodiment 1

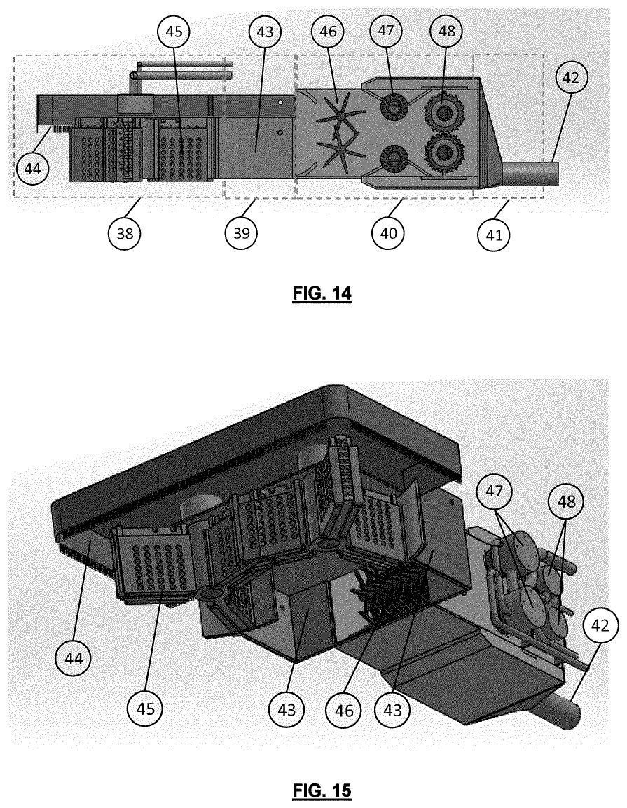

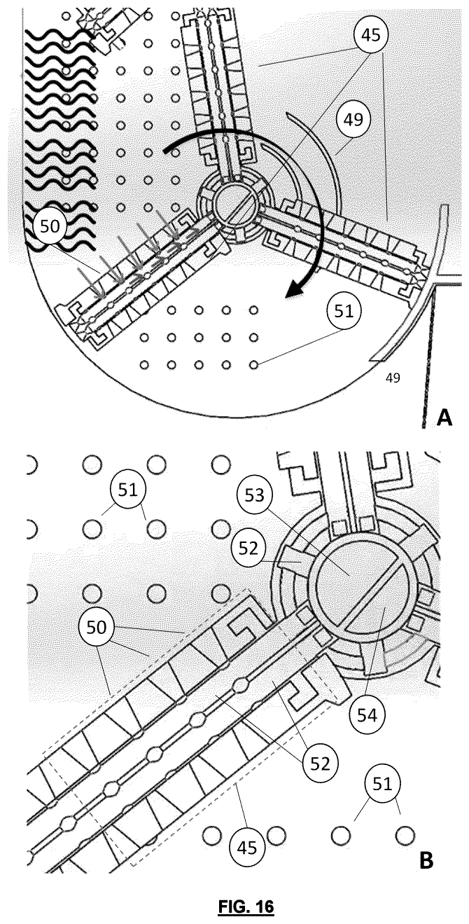

In a preferred embodiment, the underwater operating robot has a locomotion system consisting of electromagnetic tracks, which provide for the system to be attached on metallic surfaces, as shown in FIG. 9. Its removal and capture system consists of rotating perforated helices which simultaneously remove and capture bio-scaling, whereas its crushing system consists of a two-phase system which contains two roller crushers in order to reduce the particle to a specific granularity, as shown in FIG. 14 and FIG. 15. In addition to the rollers, the system has self-cleaning filters that reduce the possibility of clogging and idle time.

Being parallel to the surface, the robot attaches itself to the same by means of electromagnets arranged on the track (08), as shown in FIG. 9. This electromagnetic track (08) allows the robot to move along metallic surfaces allowing the robot to move in three degrees of freedom on the surface. This electromagnetic track (08) has electromagnet modules (15) arranged therein, in such a way that the electromagnetism forces are divided in most of the area in which the robot is moving. To control this electromagnetic force, the system will be able to decrease or increase the power available to the electromagnets (15), thus allowing a greater adhesion force, when necessary. In another configuration of the robot, a track with conventional magnets is used, in which to change the magnetic force coming from this system, the magnets are moved apart by means of a lever mechanism that promotes the relative displacement between the electromagnet and the metallic surface. The alteration of the electromagnetic force has as main function to assist in the movement of the robot; when it is removing the bio-scaling, the electromagnetic force must be greater than when the robot is moving. It is necessary to reduce the magnetic force when the robot moves, via the tracks, so that the motors that make the robot move do not need high powers.

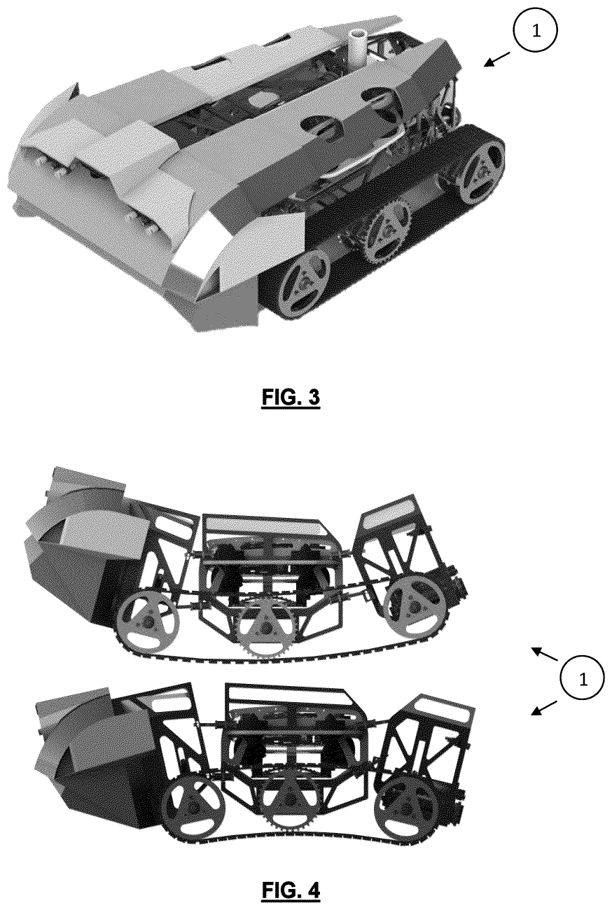

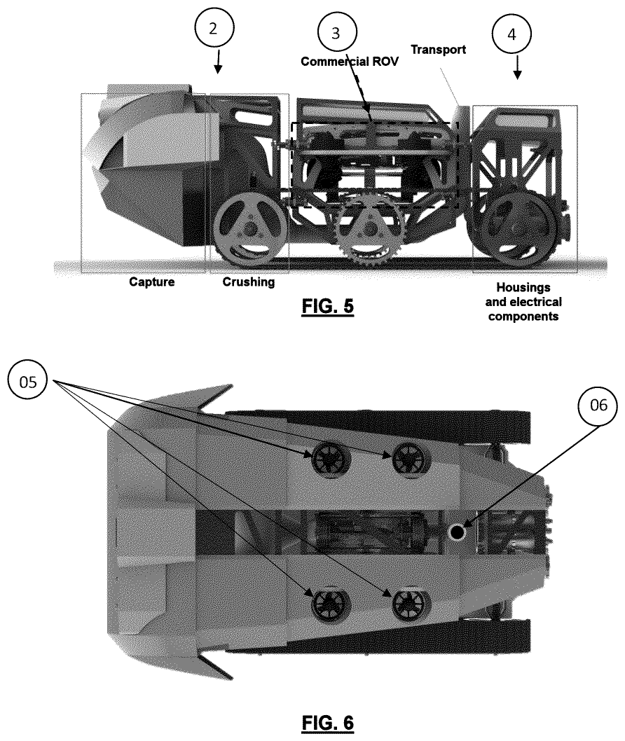

Because the robot is divided into front (2), central (3) and rear (4) modules, as shown in FIG. 5, the track has tensioning wheels (18) with individual suspensions (13), to provide the modules with individual movement. This individual movement will ensure the best adaptation of the robot on uneven surfaces and surfaces with large radii, as in the case of SS platforms, as shown in FIG. 4. The modules have mechanical attachments (16) at one point and active cylinders (17) at another point, to dampen the relative movement between the modules and help the robot conform to surfaces with large radii, whether convex or concave. This occurs because, when the robot will attach itself to the surface, not necessarily all the modules will be in contact with the metallic hull; therefore, it is necessary that there are actuators that conform the body so that the modules and the electromagnets come into contact with the surface. When in ROV mode, the active cylinders will provide greater stability between modules, inhibiting relative movement between them and thus enabling greater robot stability. The robot chassis is made in a modular way and hollowed out so that stresses from the environment are minimized.

At the front part of the robot (02), there is the first module, where the removal, capture and containment of bio-scaling is performed. After this operation, the bio-scaling is crushed in its inner part in order to assist in transport to the MSET (modular system for effluent treatment) located on the support vessel.

The central module (03) joins the other two modules and there is provided (if necessary) part of the pressure housings that contain the electronic elements for controlling and activating the actuators and for the locomotion of the system when the robot operates in ROV mode, using the Thrusters (5) to provide its locomotion.

In the third module (04) (at the rear part), possible pressure housings (11) and electronic components are arranged.

The ideal measurements for the robot to achieve its objectives is preferably between 1.0 to 1.5 m in width, 0.6 to 0.8 m in height and 1.8 to 2.0 m in length. The height of the front part, where the bio-scaling is contained, had as a requirement to be greater than 30 centimeters, which was already necessary for the removal of macro-scales of up to 30 centimeters in height.

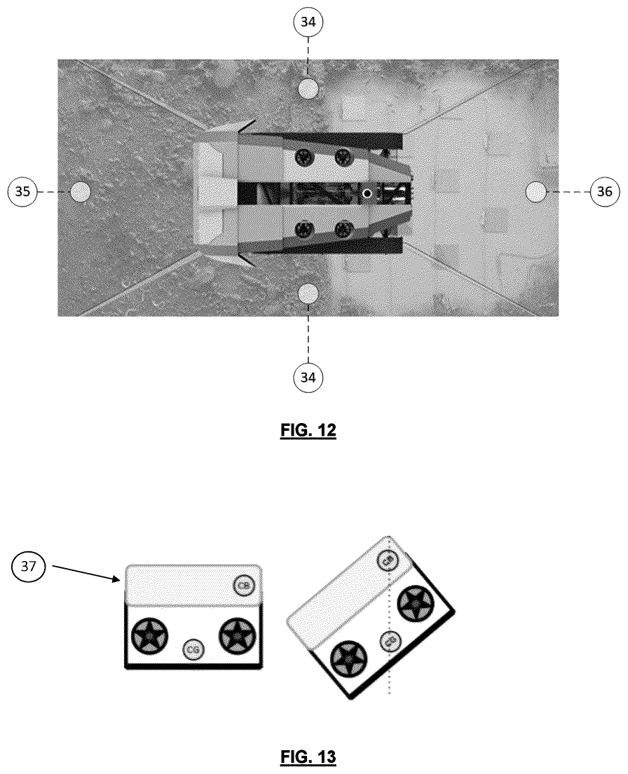

To locate in space and map and perceive the environment, there are some sensors. The sensors used to perceive the environment, such as cameras (10), multibeam sonar (24), mechanical sonar (27), ultrawide cameras (28) and particle sensor (25), are placed on the outside of the vehicle, as shown in FIG. 11. To help the cameras (10), serving as a source of artificial light, there are LED illuminators (9) also arranged on the outside of the robot.

The robotic system will have a flow rate sensor (29) that will be installed in the fluid transport piping (6). This sensor will help the system to measure the flow rate and bio-scales removal rate being performed by the crawler robot.

FIG. 9 illustrates the side and some elements of the robot, such as the track (08), electromagnet system (15), active cylinders (17), tensioning wheel (18), system fairing (20), side chassis (19), ultrawide camera (28), altimeter (32).

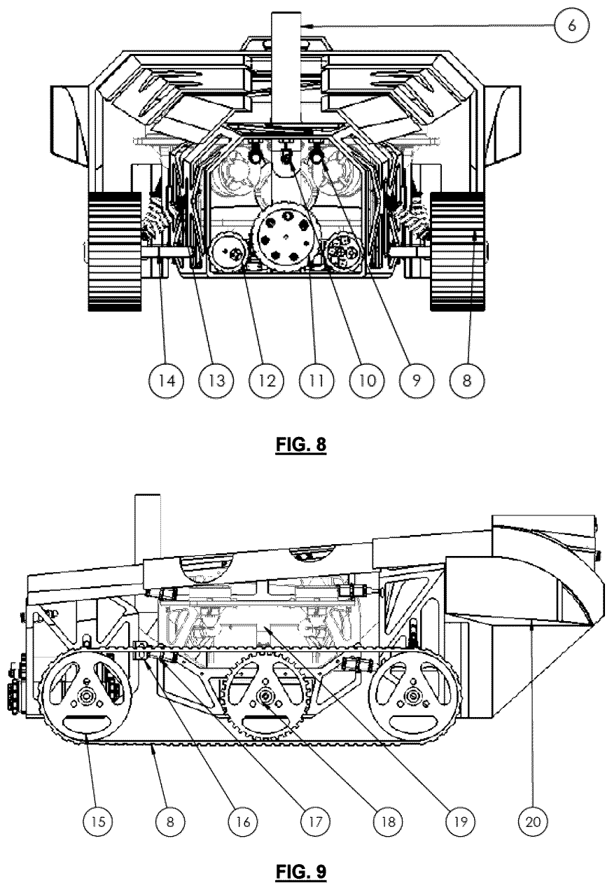

FIG. 8 shows the rear part of the robot vehicle. The transponder of the USBL positioning system (12), related to the location functionality, is also on the outside of the robot. On the other hand, inside the robot vehicle there are accommodated the INS sensors (33), Encoders (21) on the tensioning wheels (18), and depth sensor (31), also related to the location functionality. The INS sensor system (33) is a system containing gyroscopes and accelerometers, an inertia platform and a computer to measure and calculate the position relative to the starting point. By combining measurements from all four transducers and the time between each acoustic pulse, it is possible to very accurately estimate the speed and direction of movement. The SVS sensors are for measuring the speed of sound in the environment and, consequently, calibrating the DVL and other acoustic sensors that need this more accurate information. The depth sensor (31) of the barometric type would measure the depth of the vehicle compared to the hydrostatic pressure of the environment.

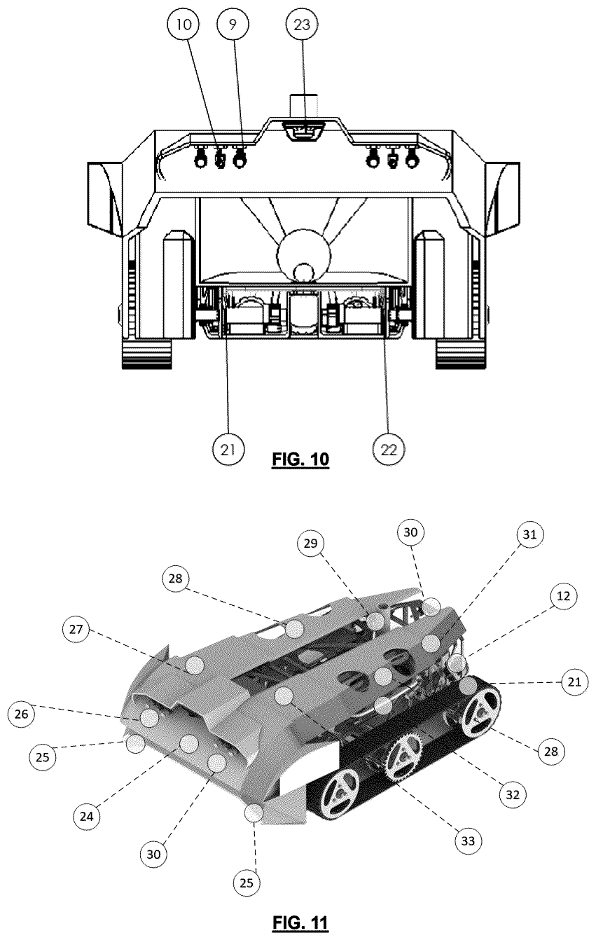

The operation of the robot on the surface to be cleaned is done remotely, aided by the system coming from the robot. This system will provide the operator with a view of the front (35), sides (34) and rear (36) of the robot, as shown in FIGS. 10 and 12. The operator will be able to know where he/she is on the vessel hull, thus increasing the efficiency of the process, since in this way the operator knows where the cleaning has already been carried out and optimally schedules the removal operation.

Once positioned, the robot starts the removal of bio-scaling through double helices of 3 straight rotating blades (45) located in the removal region (38). In the region of the capture system (39), see FIG. 14, the containment is performed by mechanical barriers (43) which contain an accommodation space that conforms to the surface to be cleaned. The captured material goes to a crushing region (40) containing a series of helices with blades like knives (46) arranged in 2 rotating shafts, and with a greater number of rotating blades, two rotating filters (47) to reduce head drop and two crushing rollers (48). The system is shown in FIG. 14 and FIG. 15.

The removal takes place simultaneously, with a mechanical impact with low rotation torque and required pressure, which provides to the removal process a lower dispersion. Added to this, there is a dynamic suction inserted in the rotating blades capturing the particles in the act of removal, offering the system an efficient containment, as it reduces the radius of dispersion of the material and the volume of water needed to assist in the capture.

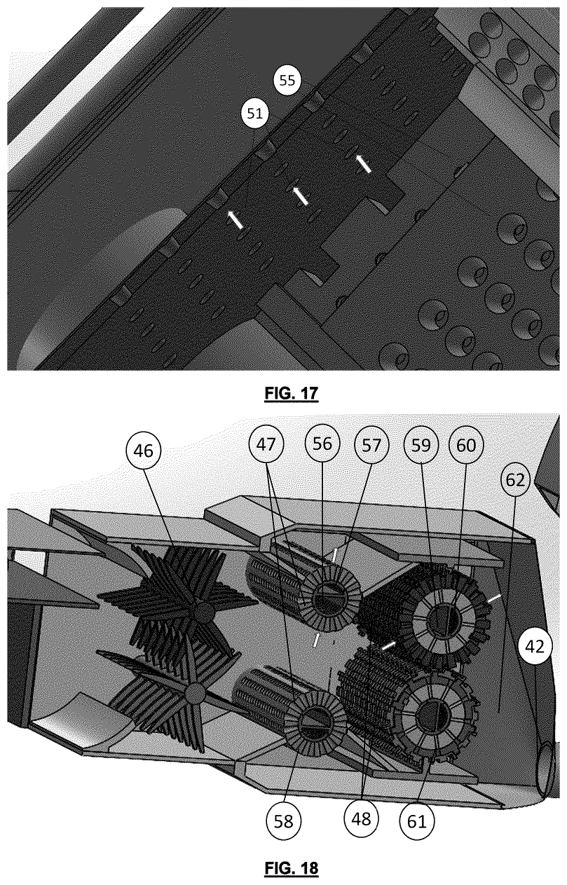

The removal and capture system consists of rotors and blades (45) that move by adjusting the height, in order to maintain contact with the surface at the time of removal, and moving parts that move around the surface of attachment; the same are pressed by springs to keep the blades in contact with the surface to be cleaned, performing the upward movement when activated by an ascending surface. The blades are made of material with less hardness than boat paint, avoiding damage to the same. These mobile blades are provided with holes (50) which, when removed by rotation (FIG. 17), misalign the holes (55), thus restricting the suction section and aligning the holes when discharging, preventing obstruction of the channels and holes.

The bio-scaling containing solid and liquid phase is directed through a pressure difference to the holes (50) that retain particles larger than their smallest diameter and the flow follows through channels (53) that have a section larger than the holes (50) thus avoiding retention of particles. The flow goes to the suction gallery of the fixed shaft through slots.

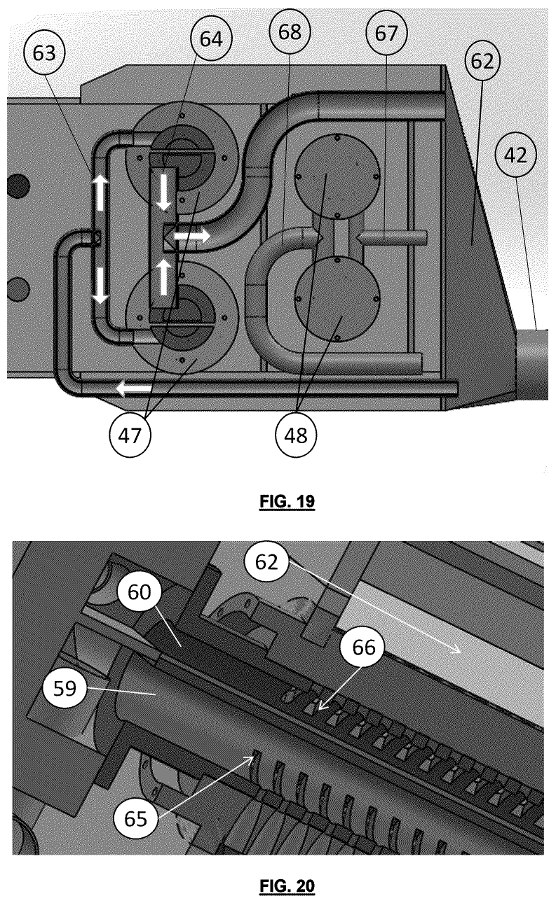

In FIG. 16 (B), a sectional view of the removal system is shown, showing the flow in the holes (50) of the blade (45) that removes the bio-scaling. The flow of water and bio-scaling comes from the pressure difference entering the holes. These holes (50) are conical; therefore, the opening towards the outside is greater than the internal one; with that, there is an inhibition that the particles that are bigger than the internal diameters enter in the system. When the blade rotates, the particles that were retained in these holes will be expelled by the positive pressure difference in the high-pressure channel (54) in the region of the capture system (39). A similar process takes place on the filters (58) and on the rollers (61), see FIG. 18.

The geometry of these holes favors the expulsion of particles retained in the process; this process of alignment and misalignment of the holes (56) is activated through cams (49) positioned in a defined location, thus increasing the output section, avoiding the residence of material retained in the act of suction. These movable parts move in the vertical direction when pressed by irregularities of high relief or low relief of the surface, overcoming the pressure of the springs, adjusting the irregularities of the surfaces, performing a more efficient removal. When the blades perform a 180° turn, the holes are aligned with a high-pressure channel (54) performing the opposite movement of the suction, that is, an expulsion of the materials contained in the capture act, providing a dynamic self-cleaning of the blades in a strategic position that allows materials to be projected towards the crushing system. In addition to this movement of the blades added to the mechanical impact removal system, the robot is provided with a hydrodynamic removal system by water jet or cavitation positioned at the lower part of the blades. This system assists in the removal containing predefined activation and deactivation positions, reducing the particle dispersion.

Aiding in the capture, there are conical holes (51) on a surface located in the region above the blades (45) that carry out the suction of the removed material, as can be seen in FIGS. 16 and 17. These holes have angles in which the smaller diameter is on the outside selecting particles of smaller sizes that could disperse in the environment. These holes are cleared of larger particles by the passage of the blades during their rotation.

Integrated with the removal and capture tools, the robot is provided, in the upper part towards the crushing system, with a cavitation device attached on a mobile rail with transversal displacement and adjustment in the lead position, allowing to enlarge the area removal tool and the adjustment of the lead angle with adjustment in position. This device gives the controller the choice of lead angle, offering versatility to the system in selecting the removal method in the face of the challenges encountered in the surface to be treated subject to a sudden change in coral sizes and physical-chemical characteristics.

The containment is carried out through attached mechanical barriers with vertical and horizontal walls and flexible walls that mold to the bio-scaling, offering a barrier to dispersion in the environment, connected to the removal system.

After removal and capture, the marine bio-scale is directed to the crushing system that takes place in a staggered way, passing through pre-reduction in size by means of two rotating shafts containing knives (46) for pre-reduction in size and segregation. These shafts are separated by a predefined distance, synchronized like a gear, with arms attached to the same with a lag in the angular position, offering a stepped compression area, thus reducing the torque needed for the step. The turning ratio happens in a two-to-one ratio, which promotes a displacement when turning between both, forcing the impact between the blades, causing reduction and segregation of bio-scaling.

To mitigate the head loss that the crusher offers to the system, a filter (47) is installed in parallel to the flow, as a self-cleaning bypass system. This filter operates in a rotating movement between the fixed shaft that has separate channels (56) and (57) in a predefined and non-communicable angular position, which, when the rotating roller provided with conical holes, coincides with the suction pipe (42), a flow is carried out into the pipe by means of the pressure difference generated by the pump. The fluid captured by the filter, when passing through the pump and returning to the discharge pipe (57), generates an opposite pressure in the holes of the mobile rollers (58) causing the expulsion of particles and cleaning of the filters (47), thus leaving the holes cleaned for one more 180 degree turn to return and cycle again.

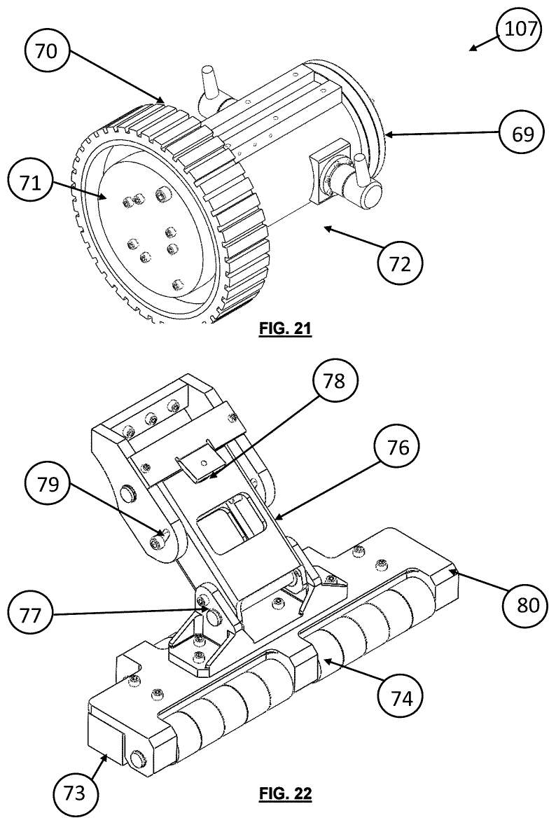

Finally, the material passes through crushing rollers (48) that each rotate around a fixed shaft, with two incommunicable water channels (59) and (60), illustrated in FIG. 20, connected to the mobile roller through conical holes (61) that connect to the fixed shaft gallery, allowing the entry of particulate material into the internal suction gallery (59) of the fixed shaft connected to a pump. These holes (61) favor the flow towards the rollers, thus reducing head drop and increasing processed flow. When the mobile crushing rollers (48) turn 180°, the holes coincide with the discharge gallery (60), which is connected to the pump, raising the internal pressure of the gallery, thus forcing the expulsion of the bio-scaling fragments that remained retained in the conical holes of the rotating parts of the filters in the act of suction. The fixed shaft holes in the suction gallery (65) have a smaller diameter than the holes in the discharge gallery (66), see FIG. 20, to avoid obstruction of the flow by particulate matter.

It is worth to emphasize that, both in the filters (47) and in the crushing rolls (48), the channels connected to the suction of the pump (42) are fed by pipes with a smaller diameter (63) and (67) than those of the pipes of suction (64) and (68), as can be seen in FIG. 19, thus favoring that bio-scaling fragments are not retained in the path, thus happening in a synchronized and cyclical way, reducing the bio-scaling recirculation in the sprockets, reducing the time of residence, increasing efficiency compared to traditional ones. The suction pipes of the filters (64) and suction pipes of the crushing rollers (68) lead to the discharge gallery (62) and are subsequently mixed so that the effluent flow proceeds to the suction pipe of the pump (42), FIG. 19. The pump is usually located outside the robot unit, usually on a support vessel.

All the primary flow of bio-scale, resulting from the crushing process, added to the auxiliary passage of the self-cleaning filters, unite and continue to conduct the material through the suction pipe (42) connected to a pump located in a pumping unit external to the robot. Another embodiment of the invention provides for a parallel pipe that independently sends the discharge flow from the filters for treatment.

### Embodiment 2

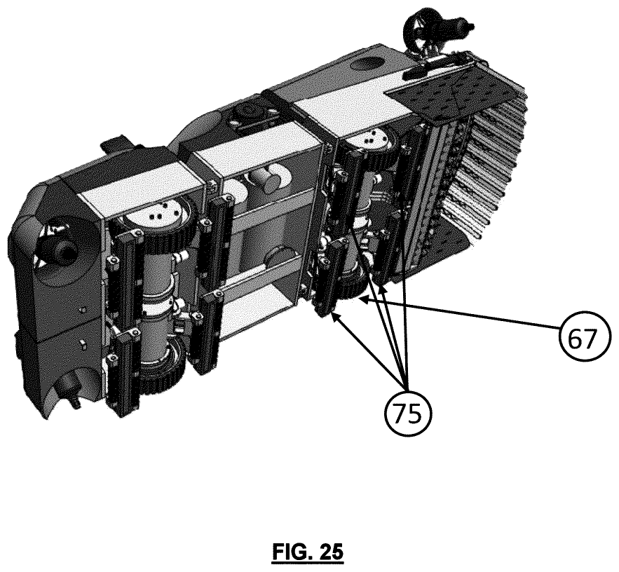

In another preferred embodiment of the invention, see FIGS. 24, 25 and 26, the movement system (106) has 4 (four) wheels (107) along its chassis (108), which allows its locomotion as a differential robot. FIG. 21 shows that the wheel system of this robot is built using a motor (69) on each wheel (107), thus allowing greater maneuverability in uneven areas, making it possible to increase the torque required for each wheel, as well as to achieve different movements of according to the motor drive configuration. The wheels consist of a tire (70) made of polymeric elements with high surface hardness, from 80 Shore, with geometry similar to wheels used in off-road vehicles, in addition to a core (71) constituted of a metallic element of high strength. The motors are arranged on the same shaft as the wheel, being activated remotely in a tele-operated way. For this set to operate in a submerged environment, a housing system (72) was used to hold the electronics and motors (69).

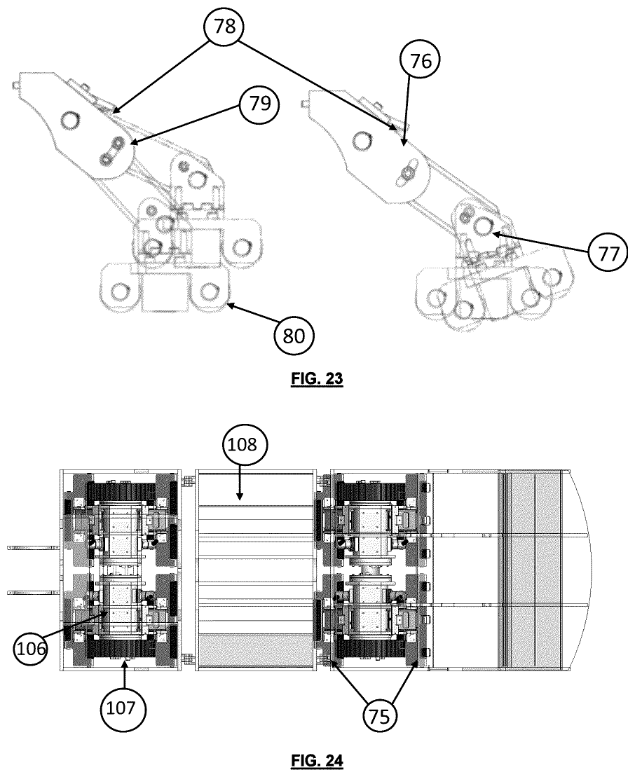

In this embodiment of the invention, the alternative magnetic attachment system, shown in FIGS. 22 and 23, consists of a set of electromagnets (73) and permanent magnets (74) arranged in the robot body. The attachment system (75) consists of a mechanism that allows the best adaptation of the robot, so that the set of electromagnets will always be in contact with the surface of the vessels. The union of electromagnets (73) and permanent magnets (74) allows the set a lower working power, resulting in a smaller electrical dimensioning. The set was calculated in such a way that the electromagnets present in the set act in a minimal way, in order to allow only the attachment of the set with a small effort, and to allow the robot to operate safely.

The magnetic attachment system, illustrated in FIG. 23, is arranged with an upper pivoting arm (76) and the rotational assembly (77), which enable the movement of the assembly against and in favor of the submerged surface. The displacement of the upper pivot (76) is sized so that the system overcomes scales, weld beads and unevenness. This degree of freedom guarantees a safety system for the set, as if there is any obstacle not mapped ahead, the entire attachment system will move, thus increasing the distance between the magnets and the surface. With this distance, the electromagnets and permanent magnets will not have enough attraction to attach the robot. With that, a mechanism was elaborated containing a machine element (78) with enough rigidity to always be pressing the magnetic actuators against the surface in a passive way. The upper pivoting arm (76) contains a mechanical movement limitation from a pin that moves inside an oblong (79), not allowing the system to displace more than dimensioned. The lower rotational assembly (77) is intended to enable the set of magnets to always be parallel to vessel surfaces, thus enabling the use of this assembly in regions of unevenness and large radii. To enable this adaptation to the surface, the system contains a pin and an oblong, which, the electromagnet support assembly (80) rotates around the pivoting arm (76), this rotation being limited by the oblong; this movement is represented in the FIG. 23.

The bio-scaling containment system removed by robot operation in this embodiment of the invention is passive. The passive containment mechanism (81) simulates a curtain of cilia that, from the movement of the robot, touches the bio-scaling in the direction of movement, containing the suspended material generated by the crushing system in a control region. These cilia are made up of small polymeric tubes flexible enough not to break scales or disperse oocytes on the seabed. The curtain, where the polymer bristles are arranged, is made up of segments (82), each arranged in such a way that the cilia overlap. This overlap allows the system to simulate a sieve, allowing only liquids or small particles to pass through. On the sides, see FIG. 34, flexible canvases (83) are arranged with small openings to allow the passage of fluids, however, inhibiting the exit of organic elements.

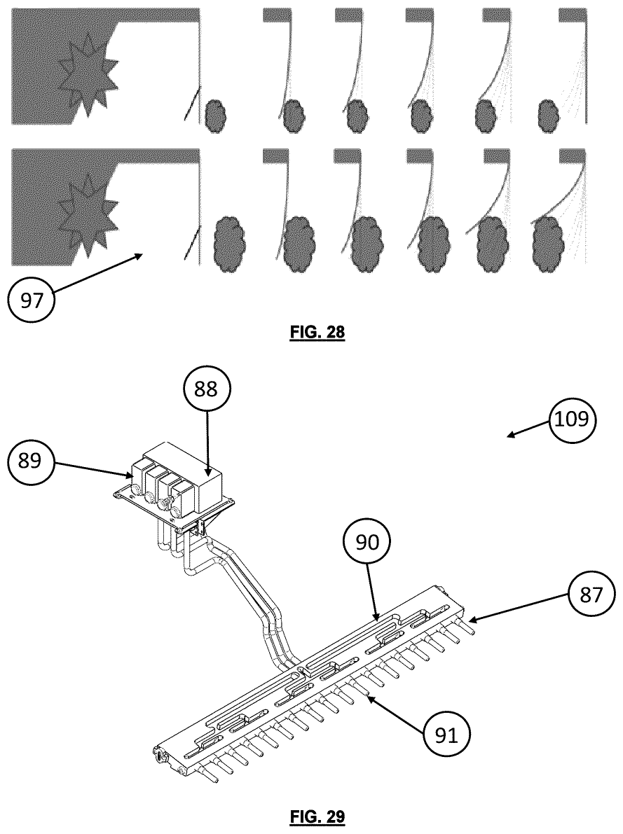

The curtain segments, as shown in FIG. 27, consist of flexible polymeric bristles (84), a polymeric core (85) and a metallic stiffener in the center (86), in order to increase the strength of the set. This set of flexible parts arranged in the front portion of the robot bend towards the interior of the cavity (97) when in contact with the solid (rigid) material of the scale. Due to its segmentation, each of the parts will adjust to the different heights that the corals have in their formation, promoting a closure between the robot and the existing formation in the place, represented by FIG. 28.

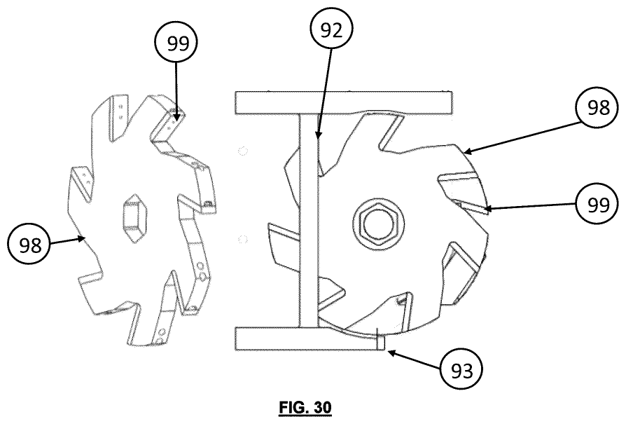

The invention in embodiment 2 uses cavitation removal devices (109) and mechanical impact (110) non-simultaneously represented respectively by FIGS. 29 and 30. The robotic platform in its operation will be able to act in high density regions of bio-scaling, with different types of animals being able to be arranged on the hulls of floating units; with this, the robot in this modality has two different methods to act in the cleaning of these surfaces.

The cavitation removal system (109), as shown in FIG. 29, is given by the use of at least 3 sets of cavitation lances (87) at the end of a manifold (88), which are driven by a system of 2-way solenoid hydraulic valves (89). The sets of lances are arranged in a labyrinth (90), in which they are activated from the valves arranged in the system. The solenoid valves (89) are mounted on a manifold (88) that connects the main piping to them, giving the option of activating each set of transverse lances, and thus enabling the removal of the entire transverse surface of operation of the robotic platform, dispensing with a mobile system for displacement of the assembly. This system is responsible for cleaning smaller scales arranged in the hull, providing a fine cleaning to the operation.

The cavitation removal system is activated in a segmented way, with each set of cavitation lances (91) activated momentarily, until the entire robot performance area is clean. This fractional drive provides less power required from the equipment on the support vessel and reduces mechanical vibrations in the robot.

The mechanical impact removal system (110), illustrated in FIGS. 30 and 31, provides the system with a coarse cleaning, being directed to large scales and with high concentration. This system operates by removing and crushing the scales placed on the hull, reducing the total amount of equipment required for the robotic platform. The crusher operates in two different ways, first removing bio-scales from the hull of ships in the form of mechanical impact and then crushing the particles that will be disposed in the control region of the containment system. The cleaning operation is carried out as follows: Fracture of the bio-scale takes place in two steps, first with the contact of the cutting discs with aluminum body (98) and cutting edges with high hardness metallic inserts (99), with preset spacing and inclination that favors the gripping and removal of the bio-scale, performing a fracture in larger pieces. These metallic inserts (99) simulate small edges that, when in contact with the bio-scaling, shear the same. From the rotating movement of the cutting discs (98) against the vertical interchangeable columns (92) and lower base (93), the particles are sheared into small pieces, thus enabling their conduction through the transport pipe (6).

The mechanical impact removal system (110) is driven by a geared motor (94) encapsulated in a housing, which drives the driving shaft (95) by chain, and this drive is divided into two parts for the transmission bearings (96), in order to balance stresses. From the rotation of the cutting discs (98), the crushing occurs, and thus, the system removes and crushes the bio-scaling available on the surfaces of vessel hulls. The rotational speed of the cutting discs (98) can be variable based on the need for the operation, as well as the inserts (99) can have different types of material.

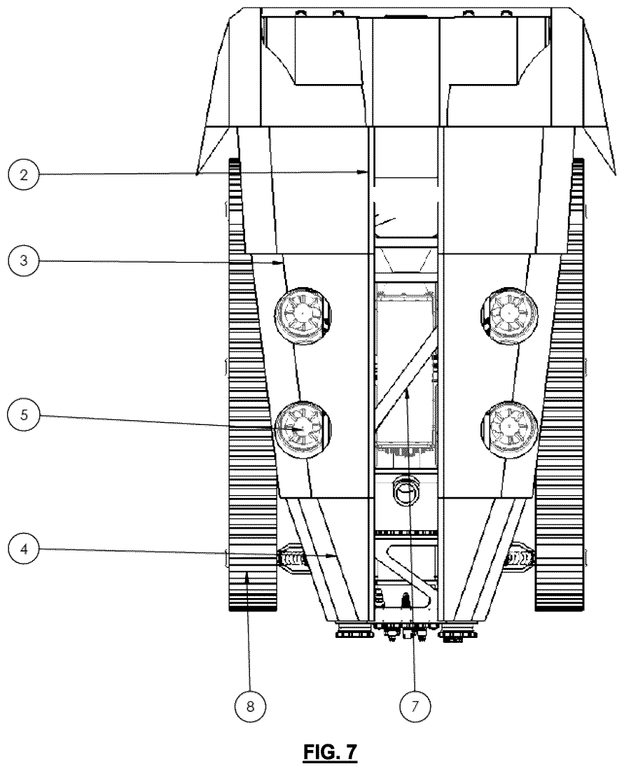

It should be noted that, although the present invention has been described in relation to embodiments 1 and 2 referring to the drawings of FIGS. 1 to 34, both may undergo modifications and adaptations by technicians skilled on the subject, depending on the specific situation, but always within the inventive scope defined in the claims.

1. An underwater robot for removal of marine bio-scaling from hulls of floating units, containing accessory components such as cameras, sonar sensors, acoustic systems, laser scanner, artificial light source, set of wheels surrounded by magnetic tracks, thrusters, characterized in that comprising:
a set of sensors to compose the non-georeferential location system containing a transponder (12) in USBL standards located on the outside, and on the inside of the robot there are the sensors of the INS system (33), a depth sensor (31), two altimeters (32), set of cameras (10) and led illuminators (9), Ultrawide camera (28), multibeam sonar (24), mechanical sonar (27), wherein, through the fusion of data, it is possible to map the position and allows perceiving the environment through a computational architecture;
the open chassis is divided into three modules: front (2), central (3) and rear (4), which are connected by active cylinders to aid in the adaptability of the system on surfaces with large radii;
a bio-scaling removal, capture, containment and crushing system in the front module (2);
flow rate sensor (29) arranged in the fluid transport piping (6);
particle sensor (25) arranged on the front of the robot;
set of cameras (26) for the operator's vision located on the side, front and rear parts, creating a full-time 360° coverage;
individual suspension system for each tensioning wheel (18), these containing a track formed by electromagnets with a grading control in the imposition of the adhesion forces to the metallic surface;
dynamic buoyancy system (37) containing air reservoirs (7) that combined with the Thrusters (05) allows a change in the dynamics of the robot movement when submerged.

2. The underwater robot according to claim 1, characterized in that the modules have mechanical attachments (16) at one point and active cylinders (17) at another point to help adapt the robot to surfaces with large radii or keep it straight when it is in ROV mode.

3. The underwater robot according to claims 1 and 2, characterized in that the front module contains the removal, capture, containment and crushing system (40).

4. The underwater robot according to claims 1 and 2, characterized in that the central module contains an ROV, containing the propelling system, the dynamic buoyancy system (37) and at the upper part the Thrusters (5).

5. The underwater robot according to claim 1, characterized in that the third module (04), rear part of the robot, contains the pressure housings (11), electronic components and other location systems.

6. The underwater robot according to claim 1, characterized in that the particle sensor (25) is of the optical and acoustic type.

7. The underwater robot according to claim 1, characterized in that the dynamic buoyancy system (37) is embodied by mobile weights (ballast) shifting the center of mass and allowing the rotation of the vehicle body.

8. The underwater robot according to claim 1, characterized in that the sides comprise at least one tensioning wheel (18) with individual suspension (13), electromagnet (15), tensioning track (8), system fairing (20), side chassis (19), ultrawide camera (28) and altimeter (32).

9. The underwater robot according to claim 1 or 8, characterized in that each tensioning wheel (18) has installed encoders (21).

10. The underwater robot according to claim 1, characterized in that it alternatively comprises a movement system (106) that has 4 (four) wheels (107) along its chassis (108), magnetic attachment system (75), passive containment mechanism (81), cavitation removal system (109), mechanical impact removal system (110).

11. The underwater robot according to claim 10, characterized in that the wheels (107) use a motor (69).

12. The underwater robot according to claim 10 or 11, characterized in that the wheels (107) consist of tires (70) made of polymeric elements with a surface hardness from 80 Shore and a core (71) consisting of a metallic element of high strength.

13. The underwater robot according to claim 10, 11, or 12, characterized in that it has a housing system (72) to hold the electronics and motors (69).

14. The underwater robot according to claim 10, 11, 12, or 13 characterized in that the magnetic attachment system (75) consists of a set of electromagnets (73) and permanent magnets (74) arranged in the robot body.

15. The underwater robot according to claim 10, 11, 12, 13 or 14, characterized in that the magnetic attachment system (75) is arranged with an upper pivoting arm (76) and the rotational assembly (77).

16. The underwater robot according to claim 15, characterized in that the support of the electromagnets (80) rotates around the pivoting arm (76), this rotation being limited by the oblong (79).

17. The underwater robot according to claim 10, 11, 12, 13, 14, 15 or 16, characterized in that it has a machine element (78) to always passively press the magnetic actuators against the surface.

18. The underwater robot according to claim 10, 11, 12, 13, 14, 15, 16 or 17, characterized in that there is the passive containment mechanism (81), which simulates a curtain of cilia, and consists of segments (82) flexible polymers.

19. The underwater robot according to claim 18, characterized in that the segments (82) consist of flexible polymeric bristles (84), a polymeric core (85) and a metallic stiffener in the center (86).

20. The underwater robot according to claim 10, 18 or 19 characterized in that the passive containment mechanism (81) has, on the sides, flexible canvas (83) with small openings to allow the passage of fluids.

21. The underwater robot according to claim 10, 18, 19 or 20, characterized in that the cavitation removal system (109) uses at least 3 sets of cavitation lances (87) at the end of a manifold (88), these being driven by a 2-way solenoid hydraulic valve system (89).

22. The underwater robot according to claim 21, characterized in that the sets of lances are arranged in a labyrinth (90), being driven from the valves arranged in the cavitation removal system (109).

23. The underwater robot according to claim 10, 18, 19, 20, 21 or 22, characterized in that the mechanical impact removal system (110) has cutting discs with an aluminum body (98) and cutting edges with metallic inserts (99), vertical interchangeable columns (92) and lower base (93).

24. The underwater robot according to claim 10, 18, 19, 20, 21, 22 or 23, characterized in that the mechanical impact removal system (110) is driven by a geared motor (94) encapsulated in a housing, which drives by chain a driving shaft (95).

25. A system for cleaning bio-scales in hulls of floating units, as defined in the inventive concept of claim 1, characterized in that it comprises:
the removal system (38) containing double helices with 3 rotating blades (45);
the capture system (39) by mechanical barriers (43) where the space conforms to the surface;
the crushing system (40) comprising a series of blades like knives (46), arranged on two rotating shafts, perforated rotary filters (47) and milling rollers (48).

26. The system for cleaning bio-scales in hulls of floating units according to claim 25, characterized in that the rotating blades (45) have a suction system (52), capturing the particles during the act of removal through holes (50) and directing them towards the channels (53), said rotating blades (45) further having a height adjustment with a spring system to have contact with the surface.

27. The system for cleaning bio-scales in hulls of floating units according to claim 25 or 26, characterized in that the holes (50) in the rotating blades (45) are misaligned (56), upon removal, restricting the suction section and aligning the holes when discharging, and when they turn 180° the holes are aligned to a high-pressure channel (54), performing the opposite movement of the suction, expelling the materials in the region of the capture system (39).

28. The system for cleaning bio-scales in hulls of floating units according to claim 25, 26 or 27, characterized in that the holes (50) are conical in shape, with the opening to the outside being larger than to the inside.

29. The system for cleaning bio-scales in hulls of floating units according to claim 27 or 28, characterized in that the alignment and misalignment of the holes (56) are performed by activating the cams (49).

30. The system for cleaning bio-scales in hulls of floating units according to claim 25, 28 or 29, characterized in that the rotating blades (45) have a hydrodynamic removal system by water jet or cavitation on the lower part of the blades.

31. The system for cleaning bio-scales in hulls of floating units according to claim 25, 28, 29 or 30, characterized in that, in the upper region of the rotating blades (45), there are conical holes (51), whose smaller diameter is in the external part, which carry out the suction of the removed material.

32. The system for cleaning bio-scales in hulls of floating units S according to claim 25, 28, 29, 30 or 31, characterized in that the upper front part is provided with a cavitation removal system (109) attached to a mobile rail of the crushing system, an adjustment in the position of the lead angle.

33. The system for cleaning bio-scales in hulls of floating units according to claim 25, 28, 29, 30, 31 or 32, characterized in that the containment system contains mechanical barriers (43) attached with vertical, horizontal and flexible walls.

34. The system for cleaning bio-scales in hulls of floating units according to claim 25, 28, 29, 30, 31, 32 or 33, characterized in that the crushing system is provided with two rotating shafts (46) containing knives, these shafts separated by a predefined distance, synchronized like a gear, with arms attached to the same and with a lag in the angular position.

35. The system for cleaning bio-scales in hulls of floating units according to claim 34, characterized in that the region containing the crusher has a filtering system (47) provided with conical holes for the filters (58) that operates in a rotating movement around a fixed shaft and which has separate channels (56) and (57) at a predefined and non-communicable angular position.

36. The system for cleaning bio-scales in hulls of floating units according to claim 35, characterized in that the crushing region, comprising two crushing rollers (48) provided with conical holes (61) that each rotate around a fixed shaft, with two incommunicable water channels, being a suction gallery (59) and a discharge gallery (60) provided with conical holes (61), wherein the fixed shaft holes in the suction gallery (65) have a diameter smaller than the holes in the discharge gallery (62).

37. The system for cleaning bio-scales in hulls of floating units according to claim 36, characterized in that there is the crushing system (40) wherein the filters (47) and the crushing rollers (48) are respectively fed by pipes with a smaller diameter (63) and (67) which respectively flow into the suction pipes (64) and (68), where they arrive at the discharge gallery (62), finally being sucked into the suction pipe (42) connected to the pump which is located in an external unit.
